(19) United States
(12) Patent Application Publication
(10) Pub. No.: US 2026/0307544 A1
(43) Pub. Date: Oct. 8, 2026

(54) UNDER STRUCTURE OF VEHICLE BODY

(71) Applicants: HYUNDAI MOTOR COMPANY, SEOUL (KR); KIA CORPORATION, SEOUL (KR)

(72) Inventors: Jiae Yong, Hwaseong-si (KR); Chulhee Heo, Hwaseong-si (KR); Dong Wook Kim, Hwaseong-si (KR)

(73) Assignees: HYUNDAI MOTOR COMPANY, SEOUL (KR); KIA CORPORATION, SEOUL (KR)

(21) Appl. No.: 19/565,287

(22) Filed: Mar. 12, 2026

(30) Foreign Application Priority Data
Apr. 2, 2025 (KR) 10-2025-0042541
Oct. 29, 2025 (KR) 10-2025-0159354

(51) Int. Cl. B60N 2/015

(52) U.S. Cl. CPC B60N 2/015

(57) ABSTRACT

A vehicle underbody structure is provided. The vehicle underbody structure includes a center floor panel configured to form a lower surface of a vehicle body, a side sill installed on opposite sides of the center floor panel to extend along a longitudinal direction of the vehicle body, a longitudinal side member installed inside the side sill to extend along the longitudinal direction of the vehicle body, a transverse seat cross member connected to the longitudinal side member and installed to extend along a width direction of a vehicle, and a double‑pocket seat mounting portion provided on the longitudinal side member and installed to allow a seat of the vehicle to be mounted.

### CROSS-REFERENCE TO RELATED APPLICATIONS

This application claims priority to and the benefit of Korean Patent Application No. 10-2025-0042541, filed with the Korean Intellectual Property Office on Apr. 2, 2025, and Korean Patent Application No. 10-2025-0159354, filed with the Korean Intellectual Property Office on Oct. 29, 2025, the entire contents of which are incorporated herein by reference.

### TECHNICAL FIELD

The present disclosure relates to a vehicle underbody structure, and more particularly, to a vehicle underbody structure applied to a low-floor platform vehicle, in which rigidity of the body is enhanced.

### BACKGROUND

Recently, the vehicle industry has been considering future mobility solutions, such as a purpose built vehicle (PBV) for purpose-based mobility.

The PBV is an example an eco-friendly mobility vehicle based on an electric vehicle (EV). A PBV may be provided with an underbody 1 formed as a low-floor monocoque platform, and may have seats installed on an upper portion of the underbody. In the case of a vehicle body applied with a low-floor monocoque platform, there is a restriction on a cross-sectional configuration of a body member to accommodate battery arrangement and satisfy ground clearance specifications (e.g., requirements), which is disadvantageous compared to other vehicle types. In addition, such a body configuration deteriorates noise, vibration, harshness (NVH) performance due to road excitation, thereby adversely affecting ride comfort and stability of the seat mounting structure.

### SUMMARY

The present disclosure provides a vehicle underbody structure in which a double-pocket seat mounting structure is applied to an interior of a side member, which is a longitudinal member of a vehicle body, thereby enhancing seat mounting rigidity and improving noise, vibration, harshness (NVH) performance of a vehicle.

An example embodiment of the present disclosure provides a vehicle underbody structure including a center floor panel configured to form a lower surface of a vehicle body, a side sill (e.g., a first side sill and a second side sill) installed on opposite sides of the center floor panel to extend along a longitudinal direction of the vehicle body, a longitudinal side member installed inside the side sill to extend along the longitudinal direction of the vehicle body, a transverse seat cross member connected to the longitudinal side member and installed to extend along a width direction of a vehicle, and a double‑pocket seat mounting portion (e.g., double-pocket seat mount) provided on the longitudinal side member and installed to allow a seat of the vehicle to be mounted.

The double‑pocket seat mounting portion may be provided inside the longitudinal side member.

The vehicle underbody structure according to an example embodiment of the present disclosure may further include an extension bracket configured to connect an outer side of the longitudinal side member and an inner side of the side sill.

The extension bracket may be fixed by welding to the outer side of the longitudinal side member and the inner side of the side sill.

The double pocket seat mounting portion may include a seat lower bulkhead installed to support opposite inner side surfaces of the longitudinal side member, and a seat side mounting bracket coupled to an upper portion of the seat lower bulkhead and coupled to opposite outer sides of an upper portion of the longitudinal side member.

The seat lower bulkhead may be formed of a first surface extending horizontally and having opposite sides fixed to inner surfaces of the longitudinal side member, and a second surface bent downward from the first surface and fixed to an inner surface and a bottom surface of the longitudinal side member.

End portions of the first surface and the second surface may be fixed to an inner surface of the longitudinal side member by welding.

The seat side mounting bracket may be formed of a third surface extending horizontally and having opposite sides fixed to an upper surface of the longitudinal side member, and a fourth surface bent downward from the third surface and fixed to a first surface of the seat lower bulkhead.

An end portion of the fourth surface may be fixed to the first surface by welding.

The vehicle underbody structure according to an example embodiment of the present disclosure may further include a plurality of seat center mounting brackets spaced apart (e.g., from each other) on the transverse seat cross member and installed to allow a seat of the vehicle to be mounted.

An inner leg of a seat of the vehicle may be coupled to an upper surface of the seat center mounting bracket.

The seat center mounting bracket may be fixed to the transverse seat cross member by welding.

In a vehicle underbody structure according to an example embodiment of the present disclosure, a line where an end portion of the fourth surface is welded to the first surface, a line where the seat center mounting bracket is welded to the transverse seat cross member, and a line at which the extension bracket is welded to an outer side of the longitudinal side member and an inner side of the side sill may be formed to coincide with one another.

By applying a double‑pocket seat mounting structure inside the side member, which is a longitudinal member of the vehicle body, seat mounting rigidity may be improved, and NVH performance of the vehicle may be enhanced.

In addition, by aligning welding lines of the center mounting bracket, the double‑pocket seat mounting portion, and the extension bracket, overall torsion of the vehicle may be prevented and side‑impact rigidity may be improved.

### BRIEF DESCRIPTION OF THE DRAWINGS

FIG. 1 illustrates a vehicle body to which a vehicle underbody structure is applied according to an example embodiment of the present disclosure.

FIG. 2 illustrates a vehicle underbody structure according to an example embodiment of the present disclosure.

FIG. 3 is an enlarged view of a double-pocket seat mounting portion in a vehicle underbody structure according to an example embodiment of the present disclosure.

FIG. 4 illustrates a coupling relationship at a first side of a vehicle underbody structure according to an example embodiment of the present disclosure.

FIG. 5 is a view illustrating a double-pocket seat mounting portion of a vehicle underbody structure according to an example embodiment of the present disclosure.

FIG. 6 illustrates a double-pocket seat mounting portion of a vehicle underbody structure installed inside a longitudinal side member and connected to an extension bracket according to an example embodiment of the present disclosure.

FIG. 7 illustrates a double-pocket seat mounting portion of a vehicle underbody structure installed inside a longitudinal side member and connected to a transverse seat cross member according to an example embodiment of the present disclosure.

FIG. 8 is a plan view illustrating a vehicle underbody structure as viewed from above a vehicle body according to an example embodiment of the present disclosure.

FIG. 9 is a bottom view illustrating a vehicle underbody structure as viewed from beneath a vehicle body according to an example embodiment of the present disclosure.

FIG. 10 is a plan view illustrating a state in which a welded line of a double-pocket seat mounting portion is installed inside a longitudinal side member of a vehicle underbody structure as viewed from above the vehicle body according to an example embodiment of the present disclosure.

FIG. 11 is a bottom view illustrating a state in which a welded line of a double-pocket seat mounting portion is installed inside a longitudinal side member of a vehicle underbody structure as viewed from beneath the vehicle body according to an example embodiment of the present disclosure.

### DETAILED DESCRIPTION

The present disclosure will be described more fully hereinafter with reference to the accompanying drawings, in which example embodiments of the disclosure are shown. The described example embodiments may be modified in various different ways, without departing from the spirit or scope of the present disclosure.

Further, in the example embodiments, for components having the same configuration, like reference numerals are used and described (e.g., only) in an (e.g., one) illustrative example embodiment, and in other example embodiments, (e.g., only) different configurations from the first example embodiment may be described.

It should be noted that the drawings are schematic and not necessarily drawn to scale. Relative dimensions and proportions of parts shown in the drawings may be exaggerated or reduced for clarity and convenience, and any dimensions indicated are merely illustrative and not intended to be limiting. In addition, the same reference numerals are used for like elements, components, or structures appearing in two or more drawings to indicate similar features. When referring to a part as being "on" or "above" another part, it may be positioned directly above the other part, or another part may be interposed therebetween.

An example embodiment of the present disclosure may represent a specific embodiment of the present disclosure. As a result, various modifications of the drawings are anticipated. Accordingly, the example embodiments are not limited to the specific shapes illustrated in the drawings, and may include variations in form (e.g., resulting from manufacturing processes).

Hereinafter, a vehicle underbody structure according to an example embodiment of the present disclosure will be described in detail with reference to the accompanying drawings.

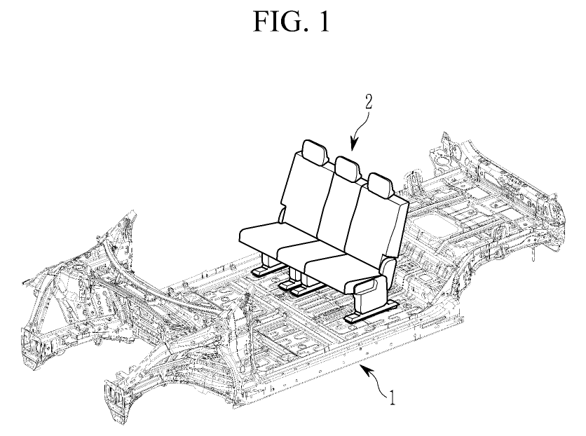

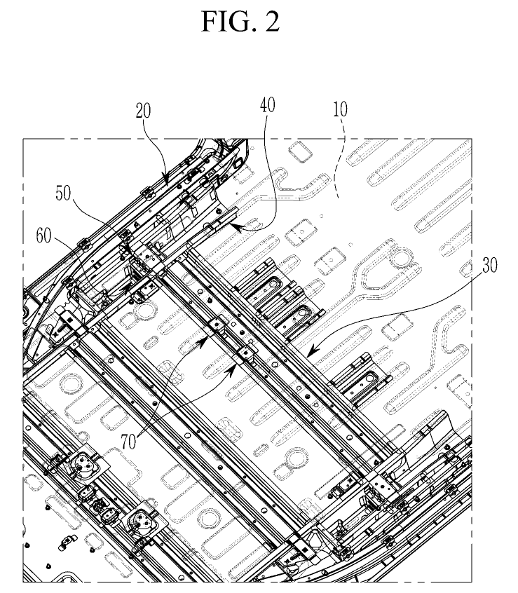

FIG. 1 illustrates a vehicle body to which a vehicle underbody structure is applied according to an example embodiment of the present disclosure, and FIG. 2 illustrates a vehicle underbody structure according to an example embodiment of the present disclosure.

Referring to FIGS. 1 and 2, according to an example embodiment of the present disclosure, a vehicle underbody structure may be applied, for example, to a body 1 of a purpose built vehicle (PBV).

The PBV may serve as an electric vehicle-based (e.g., life) module that provides various customized services to a user during a time spent traveling from a departure point to a destination, for example.

The vehicle body 1 of this PBV may be manufactured in various shapes and sizes depending on an intended purpose and specific use of the PBV.

Furthermore, the vehicle body 1 of the PBV may be used as various types of vehicles, for example, a hailing vehicle as a way of transporting passengers, a delivery vehicle for transporting goods, and/or a special vehicle such as an ambulance.

In the present disclosure, a reference direction for describing components below may be set as a front-rear direction of the vehicle body (e.g., body length direction or longitudinal direction), a width direction (e.g., lateral direction or left-right direction), and an up-down direction (e.g., height direction) based on the vehicle body.

In the present disclosure, the terms “upper end portion”, “upper portion”, “upper end” or “upper surface” of a component may indicate an end, section, segment, or surface of a component that is positioned relatively above in the drawings, whereas the terms “lower end portion”, “lower portion”, “lower end” or “lower surface” of a component may indicate an end, section, segment, or surface of a component that is positioned relatively below in the drawings

In this specification, the term "end" of a component (e.g., a first end, a second end, or opposite ends) may refer to the terminal point of the component in a given direction, whereas the term "end portion" of a component (e.g., a first end portion, a second end portion, opposite end portions, a front end portion, or a rear end portion) may refer to a portion of a component that includes an end point.

A vehicle underbody structure according to an example embodiment of the present disclosure may be applied to a purpose built vehicle (PBV) of a monocoque body type, and a vehicle body 1 may include a low-floor monocoque platform and a CTBA mounting portion formed to extend from the low-floor monocoque platform, on which a CTBA is installed.

On an upper portion of the monocoque platform body 1, a seat 2 on which an occupant can sit (e.g., can be seated) may be mounted, and in the present disclosure, a description is given of an underbody structure at a side of the seat 2, which may be positioned behind a driver’s seat.

As shown in FIG. 2, a vehicle underbody structure according to an example embodiment of the present disclosure may include a center floor panel 10, a side sill 20, a longitudinal side member 40, a transverse seat cross member 30, and a double-pocket seat mounting portion 60 (e.g., double-pocket seat mount 60).

The center floor panel 10 may include (e.g., constitute) a lower surface of the vehicle body 1, and the side sill 20 may be installed to extend along a longitudinal direction of the vehicle body 1 at opposite sides (e.g., a first side and an opposing second side) of an upper portion of the center floor panel 10.

The longitudinal side member 40 may be installed to extend in the longitudinal direction of the vehicle body 1 at an inner side of the side sill 20. The longitudinal side member 40 may be installed to be spaced apart from the side sill 20 by a predetermined distance.

The transverse seat cross member 30 may be connected to an inner portion of the longitudinal side member 40 and may be installed to extend in a width direction of the vehicle. A plurality of transverse seat cross members 30 may be provided and may be arranged parallel (e.g., to each other) along the longitudinal direction of the vehicle.

The double-pocket seat mounting portion 60 may be provided in the longitudinal side member 40, and a seat may be mounted on an upper surface of the double-pocket seat mounting portion 60.

Further, in an example embodiment, an extension bracket 50 may be provided between an outer side of the longitudinal side member 40 and an inner side of the side sill 20, and may connect the longitudinal side member 40 and the side sill 20 (e.g., to each other). The extension bracket 50 may be coupled (e.g., fixed) by welding to the outer side of the longitudinal side member 40 and to the inner side of the side sill 20.

In addition to connecting the transverse seat cross member 30 to the side sill 20, by further connecting the longitudinal side member 40 and the extension bracket 50 to the side sill 20, rigidity of the vehicle body 1 may be further secured when mounting the seat 2, and overall torsion of the vehicle body 1 may be prevented.

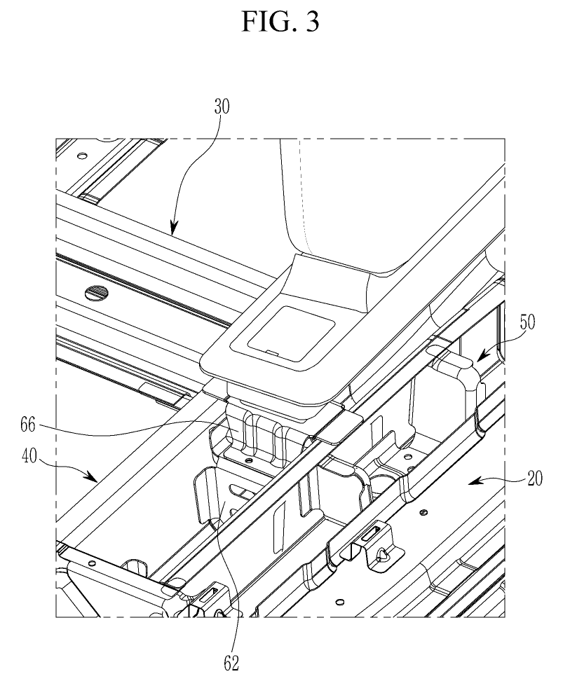

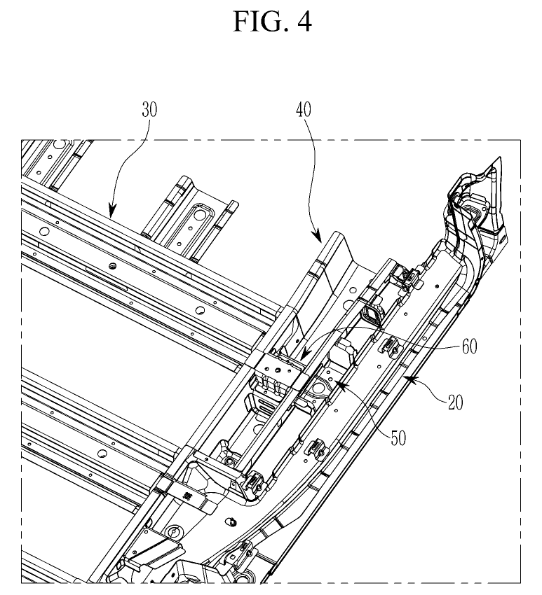

FIG. 3 is an enlarged view of a double-pocket seat mounting portion in a vehicle underbody structure according to an example embodiment of the present disclosure, and FIG. 4 illustrates a coupling relationship at a first side of a vehicle underbody structure according to an example embodiment of the present disclosure.

Referring to FIG. 3, the longitudinal side member 40 may be formed in a (e.g., U-shaped) structure in which an upper side thereof is open and an upper portion thereof is bent horizontally toward both outer sides of the longitudinal side member 40 (e.g., in the width direction of the vehicle). Inside the U-shaped longitudinal ide member 40, the double-pocket seat mounting portion 60 may be provided.

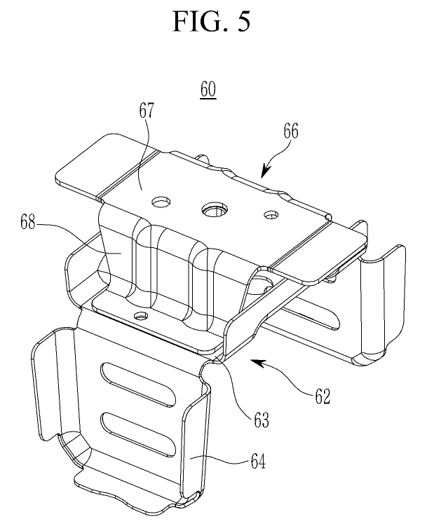

The double-pocket seat mounting portion 60 may include a seat lower bulkhead 62 (see FIG. 5), which is installed to support opposite inner side surfaces of the longitudinal side member 40, and a seat side mounting bracket 66 (see FIG. 5), which is coupled to an upper portion of the seat lower bulkhead 62 and joined to opposite outer sides of the upper portion of the longitudinal side member 40.

As shown in FIG. 4, the extension bracket 50 may be coupled to an inner side of the side sill 20 installed to extend along a longitudinal direction of the vehicle body 1, and an outer side of the longitudinal side member 40 may be coupled to an inner side of the extension bracket 50. A seat cross member 30 may (e.g., then) be coupled to an inner side of the longitudinal side member 40. Inside the longitudinal side member 40, the double-pocket seat mounting portion 60 may be installed. As such, due to a structure in which the extension bracket 50, the longitudinal side member 40, and the double-pocket seat mounting portion 60 are additionally provided on an inner side of the side sill 20, rigidity of a lower side portion of a second row of the vehicle body 1 may be further secured.

FIG. 5 is a view of a double-pocket seat mounting portion of a vehicle underbody structure according to an example embodiment of the present disclosure.

As shown in FIG. 5, the double-pocket seat mounting portion 60 may be formed of a seat lower bulkhead 62 and a seat side mounting bracket 66. The seat lower bulkhead 62 may be positioned at a lower portion inside the longitudinal side member 40, and the seat side mounting bracket 66 may be positioned at an upper portion inside the longitudinal side member 40 and may be coupled to an upper portion of the seat lower bulkhead 62.

The seat lower bulkhead 62 may be formed of a first surface 63, which extends horizontally at its end portion and is (e.g., configured to be) coupled (e.g., fixed) to inner surfaces of opposite sides of the longitudinal side member 40. The seat lower bulkhead 62 may also be formed of a second surface 64, which is bent downward from the first surface 63 and is (e.g., configured to be) coupled (e.g., fixed) to the inner surfaces and a bottom surface of the longitudinal side member 40.

End portions of the first surface 63 and the second surface 64 may be formed to be bent parallel to the inner surface of the longitudinal side member 40, and end portions of the first surface 63 and the second surface 64 may be coupled (e.g., fixed) to the inner surface of the longitudinal side member 40 by welding.

The seat side mounting bracket 66 may be formed of a third surface 67, which may extend horizontally and is coupled (e.g., fixed) at opposite sides to an upper surface of the longitudinal side member 40, and a fourth surface 68, which is bent downward from the third surface 67 and coupled (e.g., fixed) to the first surface 63 of the seat lower bulkhead 62.

An end portion of the fourth surface 68 may be formed to be bent parallel to the first surface 63, and an end portion of the fourth surface 68 may be coupled (e.g., fixed) to the first surface 63 by welding. An end portion of the third surface 67 may be formed in a shape (e.g., substantially) parallel to the first surface 63, and a lower surface of the end portion of the third surface 67 may be coupled (e.g., fixed) by welding to the bent upper surface of the longitudinal side member 40.

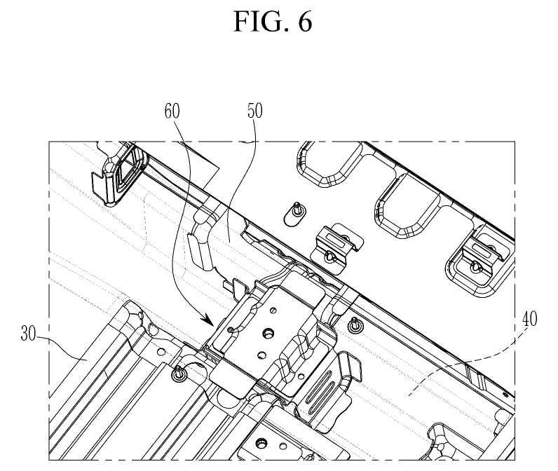

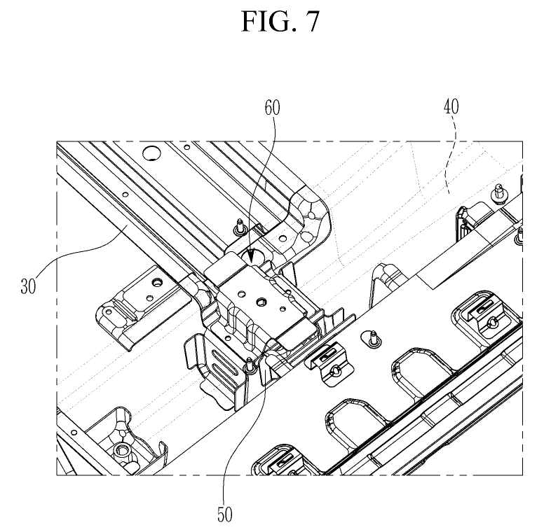

FIG. 6 illustrates a state in which a double-pocket seat mounting portion of a vehicle underbody structure is installed inside a longitudinal side member and connected to an extension bracket according to an example embodiment of the present disclosure, and FIG. 7 illustrates a state in which a double-pocket seat mounting portion of a vehicle underbody structure is installed inside a longitudinal side member and connected to a transverse seat cross member according to an example embodiment of the present disclosure.

As shown in FIG. 6, the double-pocket seat mounting portion 60 may be installed inside the longitudinal side member 40, and an outer surface of the longitudinal side member 40 and a lower surface of an outer upper portion thereof may be connected to the extension bracket 50, for example, by bolts. Inside the longitudinal side member 40, end portions of the first surface 63 and the second surface 64 of the seat lower bulkhead 62 may be coupled (e.g., fixed) to the inner surface of the longitudinal side member 40 by welding. In addition, the end portion of the third surface 67 of the seat side mounting bracket 66 may be coupled (e.g., fixed) by welding to the bent upper surface of the longitudinal side member 40.

In addition, as shown in FIG. 7, an inner surface of the longitudinal side member 40 and a lower surface of the bent upper surface thereof may be connected to the transverse seat cross member 30 by bolts.

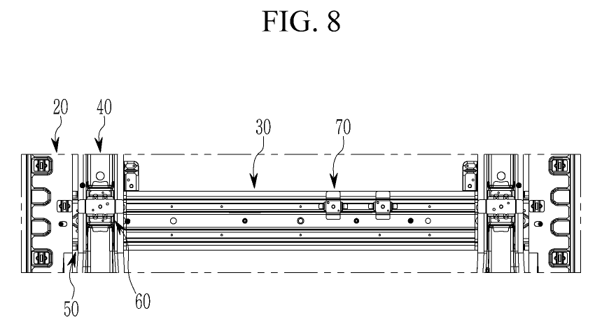

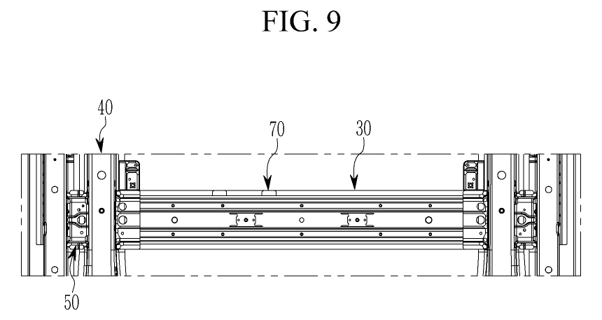

FIG. 8 is a plan view illustrating a vehicle underbody structure as viewed from above a vehicle body according to an example embodiment of the present disclosure, and FIG. 9 is a bottom view illustrating a vehicle underbody structure as viewed from beneath a vehicle body according to an example embodiment of the present disclosure.

Referring to FIG. 8, the vehicle underbody structure according to an example embodiment of the present disclosure may further include a plurality of seat center mounting brackets 70, which are provided with spacing formed on the transverse seat cross member 30 and installed such that the vehicle seat 2 is mounted. The seat center mounting bracket 70 may be coupled (e.g., fixed) by welding to the transverse seat cross member 30, so as to correspond to a position where an inner leg of the vehicle seat 2 is positioned. In an example embodiment, the number of seat center mounting brackets 70 may correspond to a number of legs of the seat.

The transverse seat cross member 30 may have end portions extending in the longitudinal direction of the vehicle that are bent to be horizontal, and a central portion thereof may have a (e.g., substantially) same height as the end portions. The seat center mounting bracket 70 may be installed to connect the bent end portions and the central portion of the transverse seat cross member 30. The seat center mounting bracket 70 may be coupled (e.g., fixed) by welding to the bent end portions and the central portion of the transverse seat cross member 30.

A horizontal height of the seat center mounting bracket 70 relative to the vehicle and a horizontal height of the double-pocket seat mounting portion 60 relative to the vehicle may be formed to be (e.g., substantially) the same, so that when the legs of the vehicle seat 2 are mounted on the seat center mounting bracket 70 and the double-pocket seat mounting portion 60, horizontality of the seat 2 may be maintained.

As shown in FIG. 9, in an underbody of the vehicle body 1, the transverse seat cross member 30, the longitudinal side member 40, and the extension bracket 50 may be formed to have a height that is (e.g., substantially) the same in a vehicle vertical direction. Accordingly, a coupled structure of the transverse seat cross member 30, the longitudinal side member 40, and the extension bracket 50 may (e.g., stably) maintain horizontality at an upper portion of the center floor panel 10.

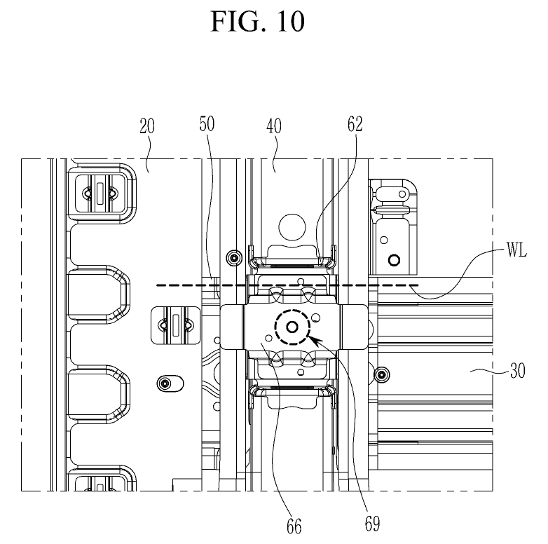

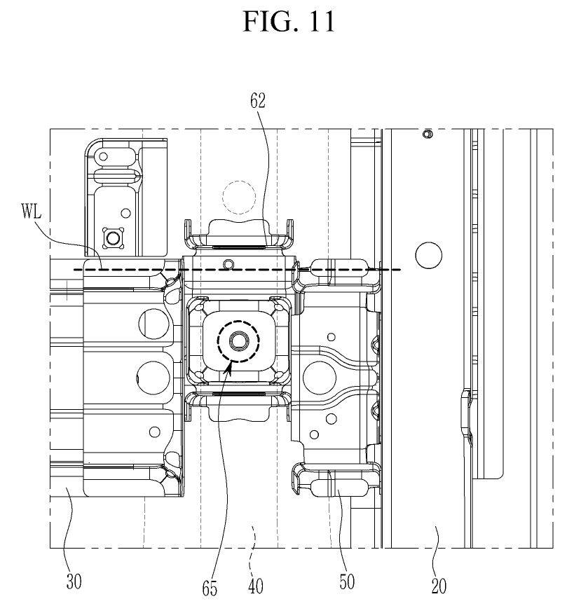

FIG. 10 is a plan view of a welded line of a double-pocket seat mounting portion installed inside a longitudinal side member of a vehicle underbody structure as viewed from above the vehicle body according to an example embodiment of the present disclosure, and FIG. 11 is a bottom view of a welded line of a double-pocket seat mounting portion installed inside a longitudinal side member of a vehicle underbody structure as viewed from beneath the vehicle body according to an example embodiment of the present disclosure.

As shown in FIGS. 10 and 11, in an example embodiment, a line at which the end portion of the fourth surface 68 of the double‑pocket seat mounting portion 60 is welded to the first surface 63, a line at which the seat center mounting bracket 70 is welded to the transverse seat cross member 30, and a line at which the extension bracket 50 is welded to an outer side of the longitudinal side member 40 and an inner side of the side sill 20 may be formed to coincide with one another, and may be indicated in the FIGS. as a “WL”.

A first seat mounting hole 69 may be formed in a central portion of the third surface 67 of the seat side mounting bracket 66, such that a leg of the seat 2 is mounted and coupled (e.g., fixed). In addition, a second seat mounting hole 65 may be formed in a central portion of the first surface 63 of the seat lower bulkhead 62, such that a leg portion of the seat 2 is inserted and coupled (e.g., fixed). The first seat mounting hole 69 and the second seat mounting hole 65 may be formed at (e.g., substantially) the same position in a vertical direction of the vehicle, such that a same leg of the seat 2 is mounted.

As such, according to an example embodiment of the present disclosure, by applying a double‑pocket seat mounting structure inside the side member (e.g., which is a longitudinal member of the vehicle body), seat mounting rigidity may be improved and NVH performance of the vehicle may be enhanced.

In addition, by aligning welding lines of the center mounting bracket, the double‑pocket seat mounting portion, and the extension bracket, (e.g., overall) torsion of the vehicle may be prevented and side‑impact rigidity may be improved.

While this disclosure has been described in connection with what is presently considered to be example embodiments, the disclosure is not limited to the disclosed example embodiments. Various modifications and equivalent substitutions could be made by those skilled in the art without departing from the scope of the present disclosure (e.g., as provided by the appended claims).

What is claimed is:

1. A vehicle underbody structure comprising:
a center floor panel configured to form a lower surface of a vehicle body;
a first side sill installed on a first side of the center floor panel configured to extend along a longitudinal direction of the vehicle body;
a second side sill installed on a second opposite side of the center floor panel configured extend along the longitudinal direction of the vehicle body;
a longitudinal side member installed within at least one of the first side sill or the second side sill, wherein the longitudinal side member is configured to extend along the longitudinal direction of the vehicle body;
a transverse seat cross member connected to the longitudinal side member and configured to extend along a width direction of a vehicle; and
a double‑pocket seat mount provided on the longitudinal side member, wherein a seat of the vehicle is configured to be mounted to the double-pocket seat mount.

2. The vehicle underbody structure of claim 1, wherein
the double‑pocket seat mount is provided within the longitudinal side member.

3. The vehicle underbody structure of claim 2, further comprising
an extension bracket configured to connect an outer side of the longitudinal side member and an inner side of at least one of the first side sill or the second side sill.

4. The vehicle underbody structure of claim 3, wherein
the extension bracket is welded to the outer side of the longitudinal side member and the inner side of at least one of the first side sill or the second side sill.

5. The vehicle underbody structure of claim 4, wherein
the double pocket seat mount includes a seat lower bulkhead installed to support a first inner side surface and a second opposite inner side surface of the longitudinal side member.

6. The vehicle underbody structure of claim 5, wherein the double pocket seat mount includes a seat side mounting bracket coupled to an upper portion of the seat lower bulkhead and coupled to a first outer side and a second opposite outer side of an upper portion of the longitudinal side member.

7. The vehicle underbody structure of claim 6, wherein the seat lower bulkhead includes a first surface extending horizontally and having a first side and a second opposite side coupled to at least one of the first inner side surface or the second opposite inner side surface of the longitudinal side member.

8. The vehicle underbody structure of claim 7, wherein the seat lower bulkhead includes a second surface bent downward from the first surface of the seat lower bulkhead and coupled to an inner surface and a bottom surface of the longitudinal side member.

9. The vehicle underbody structure of claim 8, wherein
a first end portion of the first surface of the seat lower bulkhead, a second end portion of the first surface of the seat lower bulkhead, a first end portion of the second surface of the seat lower bulkhead, and a second end portion of the second surface of the seat lower bulkhead are welded to an inner surface of the longitudinal side member.

10. The vehicle underbody structure of claim 9, wherein
the seat side mounting bracket includes a third surface extending horizontally and having at least one of a first side or a second opposite side coupled to an upper surface of the longitudinal side member.

11. The vehicle underbody structure of claim 10, wherein the seat side mounting bracket includes a fourth surface bent downward from the third surface and fixed to a first surface of the seat lower bulkhead.

12. The vehicle underbody structure of claim 11, wherein
an end portion of the fourth surface is welded to the first surface of the seat lower bulkhead.

13. The vehicle underbody structure of claim 12, further comprising
a plurality of seat center mounting brackets, wherein a space is provided between each seat center mounting bracket.

14. The vehicle underbody structure of claim 13, wherein the plurality of seat center mounting brackets are provided on the transverse seat cross member.

15. The vehicle underbody structure of claim 14, wherein a seat of the vehicle is configured to be mounted to the plurality of seat center mounting brackets.

16. The vehicle underbody structure of claim 15, wherein an inner leg of a seat of the vehicle is coupled to an upper surface of at least one seat center mounting bracket.

17. The vehicle underbody structure of claim 16, wherein at least one seat center mounting bracket is welded to the transverse seat cross member.

18. The vehicle underbody structure of claim 17, wherein a line, at an end portion of the fourth surface, is welded to the first surface of the seat lower bulkhead.

19. The vehicle underbody structure of claim 18, wherein a line, at the seat center mounting bracket, is welded to the transverse seat cross member.

20. The vehicle underbody structure of claim 19, wherein a line at which the extension bracket is welded to an outer side of the longitudinal side member and an inner side of at least one of the first side sill or the second side sill is formed to coincide.
